(19) United States
(12) Patent Application Publication
(10) Pub. No.: US 2010/0199189 A1
(43) Pub. Date: Aug. 5, 2010

(54) APPARATUS AND METHOD FOR TARGET ORIENTED LAW ENFORCEMENT INTERCEPTION AND ANALYSIS

(75) Inventors: Eyal Ben-Aroya, Rehovot (IL); Adam Weinberg, Netanya (IL); Yossi Ofek, Tel Mond (IL); Asaf Gigi, Carmiel (IL); Omri Bentov, Kfar Saba (IL)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Nice Systems, Ltd.

(21) Appl. No.: 10/595,338

(22) PCT Filed: Mar. 12, 2006
(86) PCT No.: PCT/IL06/00323

§ 371 Date: Oct. 2, 2009

(51) Int. Cl. G06F 15/173; G06F 3/048; G06F 15/16

(52) U.S. Cl. 715/736; 709/224; 715/738

(57) ABSTRACT

An apparatus and method for capturing, processing and analyzing multiple communication items, related to a hierarchy consisting of cases, sub-cases, targets or interception criteria associated with a law enforcement organization. The apparatus and method allow a user to define the hierarchy, receive and process communication items, display the content, meta data, external or additional data related to the communication items or to a target. The apparatus comprises one or more front end units responsible for filtering and capturing communications, and one or more back end units which allow the processing and presentation of the communications.

### BACKGROUND OF THE INVENTION

1. Field of the Invention

The present invention relates to intelligence systems in general, and to an apparatus and methods for intercepting interactions relating to subjects, in particular.

2. Discussion of the Related Art

Many organizations, especially law-enforcement and intelligence organizations, perform interception and monitoring of various communications means. The purpose is to extract information which relates to various subjects and is communicated over these means. According to estimations 90% of the intelligence collected around the world originates in the interception of telecommunications. Interception of telecommunications is considered a reliable source of information as people are obliged to use them and often do not take minimal precaution means while using them.

In order to organize, manage and analyze the intercepted communications the organization performing the monitoring uses a Monitoring Center (MC).

The lawful interception process model uses the stages of administration, interception and collection. The administration stage initiates the process by getting a warrant from a judge or another jurisdiction and delivering it to the service provider, where the communication items are actually intercepted.

Interception is defined as the action of duplicating certain telecommunications and providing them to a Law Enforcement MC. The entities to be intercepted are determined according to specific court orders (warrants). There are mainly two methods for implementing the actual interception process: switch based interception which relies on the existence of an internal interception function (IIF) in the network elements and passive tapping. The equipment used by each service provider comprises its own interception and mediation modules to support different methods of interception in the service. The main two methodologies are active (switch based) interception and passive (trunk based using probes) interception. Once communications are intercepted, they are delivered from the service provider to the MC. There are two basic types of products: communications content (CC) and interception related information (IRI). The process of delivery involves formatting the interception products and sending them according to delivery standards which can be international, national variants, or proprietary. Several standards exist which define the handover protocol of intercepted communications to an MC. These standards are determined by institutes such as the European Telecommunications Standards Institute (ETSI) or by its American equivalent, the Telecommunications Industry Association (TIA). The above standards are the governing standards in the world today. However some local standards and regulations have been introduced in other parts of the world as well.

However, current intelligence organizations experience ever growing difficulties in obtaining relevant data and especially in intercepting interactions related to one or more subjects, usually referred to as “targets”. One main reason for this difficulty is the growth in the number of available and used communication channels, and the exponential growth in the number of interactions. When the need arises to intercept interactions related to a certain participant or to a certain characteristic, there is often a lot of “noise”, i.e., interactions that initially seem relevant but are eventually found to be unrelated, such as when another person uses the phone line of the target, thus wasting a lot of resources on checking irrelevant information. On the other hand, a lot of important information is lost due to lack of basic knowledge, such as when the target uses another phone line than the one known to the authorities. Even when dealing with allegedly relevant interactions, by the right target using the right phone line, the mere content of the interactions may prove irrelevant.

In addition, the lack of a uniform platform for intercepting all interactions related to a target makes it hard to efficiently follow a target. Each channel dictates uses different parameters, such as phone number, IP address and others. Moreover, some channels, such as phone, differentiate between the communication initiating side and the answering side, while others such as chat communication do not make this differentiation. Another difficulty associated with certain interactions relates to the continuity of interactions, such as web browsing or chats. The problem in many cases is how to tell when an interaction started or ended

Another problem relates to organizing the cases handled by a law authority person. Since investigations, especially complex ones can branch to additional cases, involve more targets and more channels, partially share targets or information with other investigations or the like. This complexity again wastes valuable investigation resources, thus producing sub-optimal results. Yet another problem is the difficulty to indirectly identify a target. For example, a person communicating with one or more known targets might probably be an interesting target himself, but if no consistent knowledge about such person exists, he will not become a target and valuable information will be lost. Even once interactions are gathered, there are additional limitations, stemming from the lack of unified tools to review, filter, examine, and query the interactions, based not only on their metadata but also on their contents. Different analyses are preferably performed on different types of interactions, while the query and review mechanism should be shared by all types. It is desirable that the user will be able to merge information from different sources and utilize the combined information, among other purposes to better define the criteria for further interceptions. In addition, external data, such as TV broadcasts which can contribute relevant information is currently not naturally integrated with other data, although it can contribute important information.

The abovementioned difficulties, limitations, and problems, as well as additional ones not detailed above, demonstrate the need in the art for a unified method and apparatus for interactions interception, that will support defining interception criteria, intercepting, storing, automatically analyzing, and reviewing and querying the intercepted interactions according to various parameters. The method and apparatus should be able to work with all currently known communication channels, including phone, fax, e-mail, chat, web browsing, vide conferences, as well as additional existing channels and channels that will become known at a later time.

### SUMMARY OF THE PRESENT INVENTION

It is an object of the present invention to provide a novel apparatus and method for law enforcement organizations. In accordance with the present invention, there is thus provided a target-oriented apparatus for capturing one or more communication items associated with one or more targets according to one or more interception criteria, the apparatus comprising: one or more front end components, each front end component comprising one or more interception criteria operation components for determining whether one or more communication items comply with the one or more interception criteria, and one or more capturing component for capturing the communication items; and one or more back end components, each back end component comprising one or more front end interface servers for interfacing between the capturing component and the back end component, one or more hierarchy definition and update components, for defining one or more hierarchies comprising one or more interception criteria; and one or more query engines for filtering the one or more communication items according to the interception criteria. Within the apparatus, the hierarchy can further comprise one or more of the following: one or more cases, one or more sub-cases, or one or more targets. The backend can comprise a hierarchy presentation component for presenting the hierarchies. Within the apparatus, data related to a non-target person, or to an unknown target communicating with the one or more targets can be collected. Within the apparatus, the interception criteria can be associated with one or more warrants. The apparatus can further comprise one or more reviewing components for reviewing the one or more communication items. The one or more communication items can be any of the following: a telephone conversation, a fax, an SMS, a cellular telephone conversation; an e-mail message, an internet browsing session; an FTP session, an MMS, a P2P session, an instant messaging session, a chat session; a login operation, a modem call, a data transfer, a GPRS communication, the location of a cellular telephone, or a video conference. The one or more front ends or back ends can contain one or more analysis engines, each engine can be any of the following: a speech to text engine, a word spotting engine, an emotion detection engine, a language identification engine for audio, a speaker identification engine, a speaker hunting engine, a speaker separation engine, a speaker recognition engine, a phonetic search engine, a text language identification engine, a free text search engine, a categorization engine, a clustering engine, an entity tagging and relationship engine, an automatic summary engine, a language translation engine of the content, a face recognition engine, or an OCR engine of captured images. The reviewing component can comprise a map presentation component for presenting one or more maps. Each map can comprise one or more indications for one or more locations of one or more communication means associated with one or more targets. The reviewing component can comprise a playback component for playing one or more vocal communication items. The playback component can present one or more indications of one or more events from the following list: a time tag, a spotted word, a spotted phrase, a segment with high emotion detected, a comment, interception related information, DTMF, or an action item. The reviewing component can be a content presentation component for presenting the contents of one or more visual communications, or a textual presentation component for presenting the contents of one or more textual communications. The apparatus can further comprise a data retention component for preserving one or more additional data items. The apparatus can further comprise a user interface, the user interface having one or more of the following modes: a monitoring mode, a processing mode, an analysis mode, a supervision mode, a management mode, an administration mode.

Another aspect of the disclosed invention relates to a method for reviewing one or more communication items, the method comprising the steps of: defining a hierarchy, said hierarchy comprising one or more interception criteria, said interception criteria associated with one or more targets, determining whether one or more communication items comply with the interception criteria, capturing the communication item, passing the communication item to one or more back end components; and analyzing the communication item. The method can further comprise a step of using one or more results of the analyzing step for deleting, adding, or changing one or more interception criteria belonging to the hierarchy. The method can further comprise a step of storing the communication items. The method can further comprise a step of reviewing the communication item, the reviewing step can comprise listening to one or more speakers of one or more vocal communication items, or viewing one or more textual presentations of a textual communication or a pictorial presentation of an image. The one or more communication items can be any of the following: a telephone conversation, a fax, an SMS, a cellular telephone conversation, an e-mail message, an internet browsing session, an FTP session, an MMS, a P2P session, an instant messaging session, a chat session, a login operation, a modem call, a data transfer, a GPRS communication, the location of a cellular telephone; or a video conference. Within the method, analyzing the communication item can use one or more of the following engines: a speech to text, a word spotting, an emotion detection, language identification for audio, speaker identification, speaker hunting, speaker separation, speaker recognition, phonetic search, text language identification, free text search, categorization, clustering, entity tagging and relationship, automatic summary, face recognition, language translation of the content, or OCR engine of captured images. The method can further comprise a real-time alert presentation step for presenting in real-time or near-real-time an alert concerning one or more communication items. The method can further comprise a step of presenting on a map one or more indications for one or more locations of one or more communication means associated with one or more targets. The method can further comprise an IP expansion step for determining additional information about a target.

### BRIEF DESCRIPTION OF THE DRAWINGS

The present invention will be understood and appreciated more fully from the following detailed description taken in conjunction with the drawings in which:

FIG. 1 is a schematic block diagram of the disclosed apparatus, in accordance with a preferred embodiment of the disclosed invention;

FIG. 2 is a schematic flowchart of the disclosed method, in accordance with a preferred embodiment of the disclosed invention;

FIG. 3 is an illustration of a screen shot of the system in monitoring state with a playback pane, in accordance with a preferred embodiment of the disclosed invention;

FIG. 4 illustrates an on-line alert of an activity, in accordance with a preferred embodiment of the disclosed invention;

FIG. 5 is an illustration of a screen shot of the system in monitoring state with a content pane, in accordance with a preferred embodiment of the disclosed invention;

FIG. 6 is an illustration of a screen shot of the system in monitoring state with a map pane, in accordance with a preferred embodiment of the disclosed invention;

FIG. 7 is an illustration of a screen shot of the system in processing state, in accordance with a preferred embodiment of the disclosed invention;

FIG. 8 is an illustration of a screen shot of the system in processing state, with a translation pane, in accordance with a preferred embodiment of the disclosed invention;

FIG. 9 is an illustration of a screen shot of the system when defining a query, in accordance with a preferred embodiment of the disclosed invention;

FIG. 10 is an illustration of a screen shot of the system in supervision mode, in accordance with a preferred embodiment of the disclosed invention;

FIG. 11 is an illustration of a screen shot of the system in management mode, in accordance with a preferred embodiment of the disclosed invention;

FIG. 12 is an illustration of a screen shot of the system when presenting the results of a speaker hunting activity, in accordance with a preferred embodiment of the disclosed invention; and

FIG. 13 is an illustration of a screen shot of the system when presenting a report, in accordance with a preferred embodiment of the disclosed invention.

### DETAILED DESCRIPTION OF THE PREFERRED EMBODIMENT

### Definitions

IMSI—a unique number that is associated with all GSM and UMTS network mobile phone users. The IMSI is stored in the subscriber identity module (SIM) and is sent by the device to the network and is used to look up the other details of the mobile in the home location register (HLR) or as locally copied to the visitor location register (VLR).

IMEI—The International Mobile Equipment Identity is a number unique to every GSM and UMTS mobile phone. It is usually found printed on or underneath the phone's battery and can also be found by dialing a predetermined sequence into the phone. The IMEI number is used by the GSM network to identify valid devices.

HI1—Handover Interface 1.0 is a lawful interception protocol. HI1 is used for communication between a communications service provider and a law enforcement monitoring facility, concerning who and when to target.

PCAP—an application programming interface for packet capturing. PCAP may be used by a program to capture packets traveling over a network and, in newer versions, to transmit packets on a network at the link layer.

The present invention overcomes the disadvantages of the existing systems and methods by providing a novel apparatus and method for filtering, intercepting, processing, viewing, and querying about interactions associated with one or more intelligence subjects, known as “targets”. The present invention comprises one or more front end units, in which interactions are intercepted and filtered, and one back end unit to which the interactions are passed, and in which they are processed, reviewed and otherwise handled by the personnel of an at least one law enforcement agency. The back end is sometimes called monitoring center (MC). Each front end unit is dedicated to one center point of a communication channel, such as a telephone operator, a cellular operator, an internet service provider or the like and serves for capturing interactions passing through that point according to predetermined interception criterions and passing them to the MC. The interception is either active (switch based) or passive (trunk based using probes), according to the equipment used in the front end. Passive interception is more likely to occur in intelligence-related cases, while active interception is more related to law-enforcement cases, which are governed by warrants limiting the interception to specific conditions. The captured communications comprise either the communications content (CC), the interception related information (IRI) or both, according to the type of equipment and the availability of the data. The apparatus is preferably fully compliant with both ETSI and CALEA as well as with legacy facilities based interception methods and other standards or proprietary protocols. The back end unit is preferably located where the investigators operate, but it can also be located anywhere else, provided it can be remotely accessed by the investigators. At the back end unit, the interception criteria to be activated at the front ends are defined by one or more users. The back end unit also receives the interactions captured by the various front end units, processes or analyzes it so users can access the information, review it, and update the interception criterions.

The interactions to be captured are defined using a hierarchy of cases, sub-cases, targets, i.e., involved persons or organizations, and interception criteria relevant to one or more communication channels of a target. The hierarchy allows the user to navigate within the different entities within the system. Various manipulations on the different entities in the system, including for example sharing of targets or interception criteria between cases, complex queries, incorporation of additional processing and external data, are enabled. The apparatus has a multiplicity of modes, for example a monitoring mode in which a user monitors communications real-time or near real-time and decides whether to store them. Another mode is processing mode, in which a user views queries for, retrieves and stored communications. In all modes, the apparatus is preferably target-oriented, i.e., when a communication is presented, the target is clearly marked, even if he or she is not a main participant in the communication. For example, in e-mail messages, the target will be highlighted even if his name is in the CC or even BCC field, in a phone conversation it will be marked even of the call was captured due to the other person, and the like.

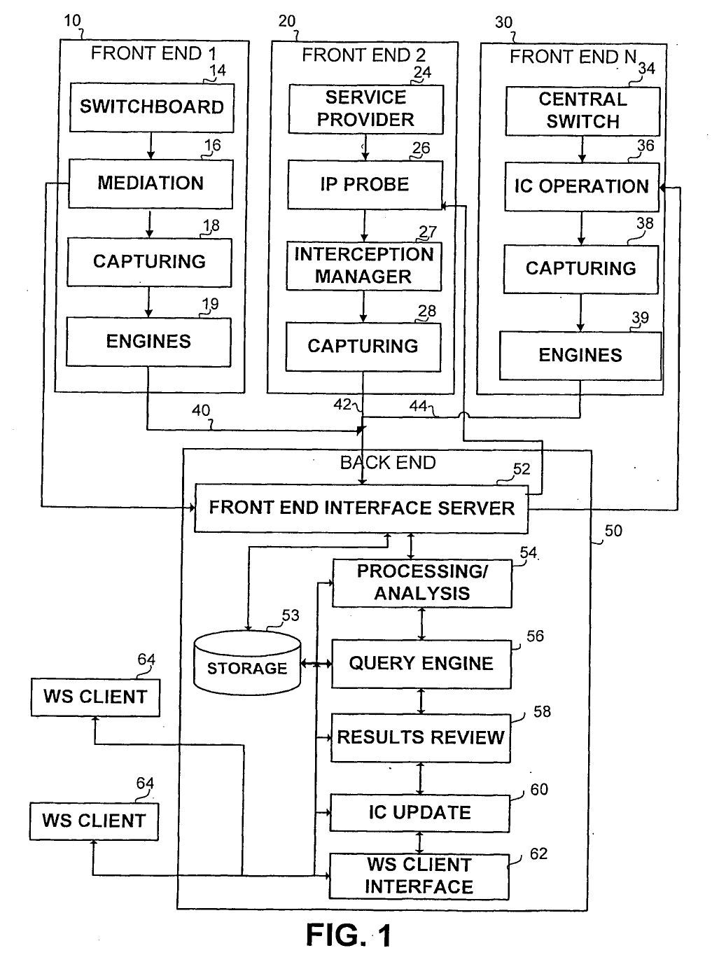

Referring now to FIG. 1, showing a schematic block diagram of a preferred embodiment of the disclosed invention. The interactions are intercepted at one or more front ends and are transferred to a back end. The exemplary embodiment includes front end 10 relating to telephony, front end 20 relating to an interne service provider and front end 30, relating to a general switch, presented here for demonstrating a non-specific front end. The apparatus further comprises back end 50. Each front end preferably supports multiple criteria for multiple back ends. For example, different law enforcement authorities can apply separate rules regarding separate numbers, and the calls relevant for each authority will be transferred to the back end of the relevant authority. Front end 10 relates to intercepting telephone or fax interactions. Front end 10 comprises a telephony switchboard 14 of a commercially available type such as those produced by Ericsson, Nortel, Motorola, Cisco, or the like, through which all interactions pass. Alternatively, switchboard 14 can be replaced by a component of a switch, or a component joined to the switch that enables the transfer of calls. Front end 10 further comprises a mediation component 16 which applies one or more interception criteria as set and defined by one or more users as will be detailed in association with the back end below. The interception criteria can include raw data such as calling number, dialed number, location, IMSI, IMEI, application (for example e-mail, http, web page or the like), port, IP address, Internet MAC address or call metadata, or data which is a result of further processing, such as identified language based in audio or text, keyword comprised in text, speaker identified by voice print or other data related to the content of the interaction. In some cases which are more likely to be intelligence-related than law-enforcement related the interception criteria can further include more complex conditions, available from the data of the interaction itself, and not from the meta data available from the switchboard. Such data can include words spotted within the interaction, a certain speaker identified as a participant in an interaction, an emotional level within a telephone interaction, a certain data item within a fax, or another feature that can be identified within an interaction. In the case of speaker identification, another added value of using the engine is the minimization of monitored and captured communications, i.e. determining whether the communication item complies with an interception criteria anytime during the interaction and not just at he beginning. For example, in some law enforcement organizations, recording is allowed only of the suspect himself, and only in calls related to the suspicions. Identifying the speaker throughout or anytime during the interaction enables a listener to start listening and possibly recording as soon as the target himself starts speaking, thus avoid missing the call because another person started the conversation as is often done by law-aware targets.

The criteria checked by mediation component 16 can involve in-bound related parameters of a communication, such as calling number, as well as out-going parameters, such as a called number, geographic location of called entity, etc., or a combination thereof. Mediation component 16 preferably comprises components for analyzing all the relevant information in the relevant formats expected to be filtered by component 16, such as components for parsing the different formats of fax communication and the like. The intercepted telephone or fax communications are captured by capturing component 18, which can be either passive (i.e. no support is required from the network elements related to telephony or internet) or active (use internal interception function, i.e., the switchboard transfers or duplicates interactions for capturing according to predefined criteria. Some interception criteria, such as a word or a phrase spotted in a vocal interaction can only be decided during or after the interaction, so there is a need to “pre-capture” an interaction, analyze it, check it against the criteria, and if the interaction complies with the criteria, then to transfer it. For this end, front end 10 preferably comprises one or more analysis engines 19, such as but not limited to: speech to text; word spotting; phonetic search, emotion detection; audio language identification; speaker recognition, speaker identification (identifying if a speaker is known to the system); speaker verification (is the speaker who he is claiming to be), speaker hunting (does the speaker belong to a predetermined group of speakers); or a combination of two or more criteria. Some criteria may even necessitate additional engines such as speaker separation for enabling analysis such as emotion detection. Those interactions that comply with the criteria are transferred by dedicated one or more E1 lines 40 to the back end, where they are further processed, analyzed, reviewed, stored or otherwise used. Front end 20 is an exemplary embodiment for a front end associated with an internet service provider. Component 24 is the standard equipment used by the service provider, including one or more wide area networks (WAN) and/or local area networks (LAN), router, radius server, authentication server, or other components, and IP probe 26 is a smart listener, aware of the different communication methods passing through service provider equipment 24 and their specific properties. Front end 20 further comprises interception manager 27 for parsing and filtering the various communications. For example e-mail messages are filtered according to interception criteria regarding the different fields, for example the sender, receiver, date subject, body, attachments, or others, including a combination there of. Web browsing can be filtered according to sites, pages or other criteria. For the different communication methods, it is required to determine when the communication starts and stops or alternatively, when to start or stop capturing each communication, which depends on the communication type. For e-mail messages the whole contents are preferably captured. In a chat session, which can be active for hours or even days, preferably a timeout exceeding a predetermined duration is used to decide to end a capturing; a voice or a video communication, including voice over IP (voip), is captured as long as the call lasts; for MMS communication the entire contents is captured; for HI1 the notification is captured; in faxes the whole fax; in a modem call the whole call is captured, out of which many events are optionally derived and captured as well; a data transfer, similarly to a modem call is wholly captured, for example PCAP—the data intercepted via a passive probe; in GPRS—the whole communication for 2.5 cellular generation communication; newsgroup are captured like an e-mail; web browsing is captured according to predetermined pages; FTP is captured as a whole session, starting at login and lasting until logout, with the exception of a timeout exceeding a predetermined duration, and wherein each upload or download of a file is captured as a separate event; capturing of telnet sessions is terminated by a timeout; instant messaging sessions are captured similarly to chat, but voice, video and transferred files each comprise a separate event. P2P sessions, if not encrypted comprise a separate event for each medium wherein text is transferred with timeout; updated location of a cellular device is captured; for login operations, the information both for the ISP access and for the applications is captured; web mail using http is identified as e-mail both when sent and when received (relate to browsing); for secured information, such as a password, the encrypted event is stored.

A mechanism of IP expansion, for determining additional information, and thus possibly additional interception criteria of a target can be employed as well. The idea is to use a known communication mechanism of a target, such as an e-mail address, and by locating and following the IP address this communication flows through, get additional communication channels of the target, such as a nickname in a chat, additional e-mail addresses and the like. The spanning can sometimes be misleading, for example when a person is using a public computer, such as in an internet café or a public library, so the spanning type and duration are preferably limited by the active interception criteria. Certain activities can be ignored, such as downloading of large quantities of data, for example music, films or the like. IP Probe 26 and interception manager 27 can be located either at the service provider or anywhere on the internet backbone between countries. Different technologies should be employed according to the different characteristics of the network, such as ATM networks, frame-relay protocol, or the like. The intercepted data is captured by capturing component 28. As explained in association with front end 10 above, front end 20 may also comprise analysis engines, which should perform analyses on all types of information. The analysis types include, but are not limited to: text language identification, free text search, categorization, clustering, entity tagging and relationship, automatic summary, language translation of the content, OCR of captured images, or others. The captured interactions are preferably transferred to the back end by wide area network (WAN) connections 42. As a generalization for a front end unit, consider unit 30. Unit 30 comprises a central switch 34, such as a switchboard in the case of telephony communication or the service provider equipment in the case of an internet provider. The communications passing through central switch 34 pass through interception criteria (IC) operation and management component 36, which applies the criterions as set and defined by users to the communication, and filters which communications are to be captured and which are not. Some of the filtering may occur after the communications were analyzed by analysis engines 39 as detailed above. IC operation component 36 optionally receives information from central switch 34 relating to certain parameters, such as telephone numbers, and may also analyze the communication in order to extract, for example the used protocol or other data items. IC operation component 36 can test in-bound related parameters, out-bound related parameters, general parameters (such as communication time) or any combination of the above. A combined criteria can be called a smart alert. Once a smart alert is defined, it is stored for on going usage, and not just interpreted for immediate usage. The communications that are of interest are captured by capturing component 38 and are transferred by line 44 to the back end. Line 44 can be of any type, applicable for the relevant interactions type. The general presented structure can be applied to any required communication channel, such as a cellular operator (2G, 2.5G, 3G), a satellite operator, a video conference line, a tracking location of a cellular telephone, ISP, fixed telephony. The presented structure can further be applied to any technology within the elements or among them, including GSM over the air, internet backbone, telephony backbone for international gateways, or other technology currently available or that will be available in the future. Complex interception criteria can also be applied by mediation component 16, IP probe 26, IC operation 36 or a combination thereof, if common access is provided to more than one communication channel. Such complex criteria can be “user browsed a certain internet site, then called a certain telephone number and then went to a certain location”. Back end unit 50 receives all captured interactions for further analysis, review and continuation of operation. Back end unit 50 comprises a front end interface server 52. Front end interface server 52 receives interactions and meta data from capturing units 18, 28 and 38, and sends new or updated interception criteria together with accompanying information, or deletion notifications concerning interception criteria to IC operation components 16, 26 and 36 of front end units 10, 20 and 30 respectively. Front end interface server 52 is responsible for correlating between the call content and the IRI, receiving of notifications from the networks, connecting to all networks (telephony, Internet, and others), maintenance of a list of ICs of all systems of the above networks, distribution of received communications to the relevant system(s), and providing real-time monitoring to the different systems. Back end 50 further comprises storage 53 that contains the stored interactions, related meta data, saved queries, and any other data any of the users wishes to save. The storage is preferably divided into short-term storage, comprising incoming information, and long-term storage, comprising processed information and communications that a user decided to keep. Back end 50 further comprises processing/analysis component 54, which is responsible for processing and analyzing different captured interactions. Processing/analysis component 54 preferably comprises a multiplicity of analysis engines, such as transcription engine for audio signals, word spotting engine for audio signals, face recognition for video signals, emotion detection for audio or video signals, fax analysis, modem analysis, internet analysis, executive connect (real time forwarding of targets' conversation to the operator's cell phone), or the like.

Since interception criteria are applied both at the front end and at the back end, it will be appreciated by persons skilled in the art, that analysis engines, such as the voice recognition, speech-to-text, emotion and others can be installed and used at one or more front end locations for purposes of filtering interactions to be intercepted, or at the backend to be used as part of the analysis of a communication, or in both. The engines are possibly activated with different parameters for the front end and for the back end, related, for example to the tolerance towards false alarms vs. miss detected, required accuracy and other considerations. Component 54 preferably comprises a dispatcher for dispatching the relevant interactions to the relevant engine. Back end 50 further comprises query engine 56, which runs queries entered by the user on database 53, thus retrieving intercepted interactions that comply with certain conditions. Another component comprised by back end 50 is one or more results review component 58, which is a platform for the user working with the system. Review component 58 working with the interactions captured by the various front end units associated with back end 50. The platform enables the review, analysis, and all manipulations associated with the interactions. Yet another component of back end 50 is one or more IC update component 60, in which the user reviews and updates the working environment, including cases, sub-cases, targets and interception criteria. Another component is work station (WS) server 62, which serves as a gateway into the system, mediating between the clients and the system servers and is also responsible for the database access of the clients. The user, i.e. investigators, administrators and other personnel access the system through one or more WS clients 64. The connection between the clients and the server can be implemented using any client-server technology. The mentioned components, including IC operation components 16, 26 and 36, capturing components 18, 28 and 38, front end interface server 52, query engine 56, results review component 58, IC update component 60, and WS client interface 62 are preferably implemented as computerized components, preferably as computing platforms, such as a personal computer, a mainframe computer, or any other type of computing platform that is provisioned with a memory device (not shown), a CPU or microprocessor device, and several I/O ports (not shown). Alternatively, one or more of the abovementioned components can be implemented as a DSP chip, an ASIC device storing the commands and data necessary to execute the methods of the present invention, or the like. Each component can comprise an independent computing platform running one or more applications. Alternatively, any combination of the components, especially components belonging to the same front end units or components belonging to the back end unit, can be co-located on the same computing platform or share common resources. However, it is not a requirement that any combination of components is located within a geographic proximity. For example, results review component 58 and IC update component 60 can be implemented as client-server systems, such that database 53, query engine 56, a server component of results review component 58, a server component of IC update component 60 and workstation client interface 62 can reside in one location, and a multiplicity of results review clients and IC update client components can reside on multiple nearby or remote computer platforms. The client parts of results review component 58 and IC update component 60 can be separate or integrated into one working environment. Each computing platform can include a storage device (not shown), storing the relevant applications, which are a set of logically inter-related computer programs and associated data structures that interact to perform the steps associated with the disclosed invention. Database 53 can be a magnetic tape, a magnetic disc, an optical disc, a laser disc, a mass-storage device, or the like. It will be appreciated by persons skilled in the art that multiple front end units of any type can be associated with any back end component, and that multiple IC operation components, and multiple capturing components can co-exist within any front end unit, and be associated with multiple back ends.

In order to facilitate the organization of the workflow by the investigator, a novel classification of the involved entities is disclosed. The presented embodiment comprises a number of modes, wherein each mode is designed to be used by a different group of people, and possibly at different stages of an investigation. Some of the possibilities and features are enabled in all modes and for all users (although the viewed information might be different due to difference in permission levels), while others are enabled for one or more modes or users and disabled to others. The different modes are monitoring, processing and analysis, which a are mainly used by technical users such as investigators, while supervision, management and administration modes are usually used by the administrative staff.

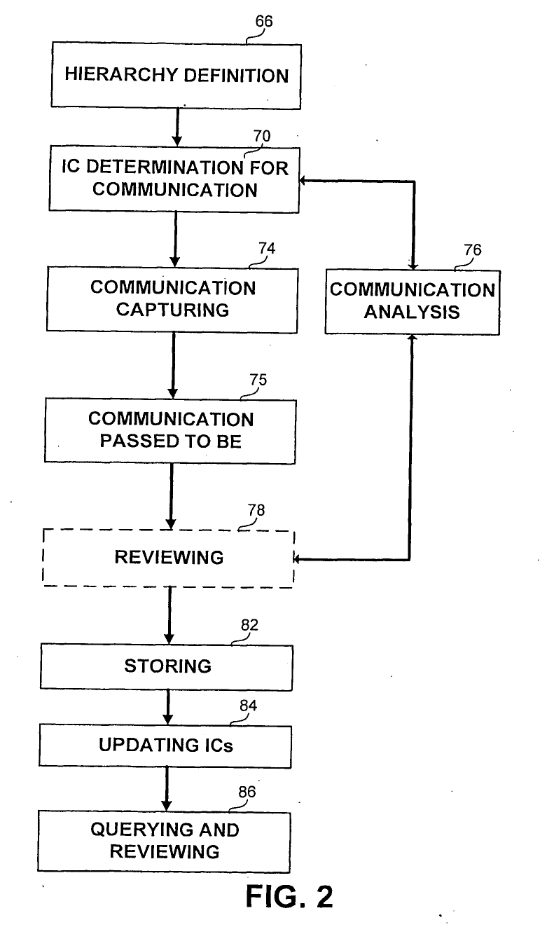

Referring now to FIG. 2, showing the main steps of the method of the disclosed invention, preferably as used with the apparatus of FIG. 1. The first step of the method is hierarchy definition step 66. The hierarchy comprises one or more cases, sub cases, targets and interception criteria (IC). The ICs are optionally derived from and are in accordance with one or more warrants. Each IC is applied at one or more front end, such as a switchboard of a telephony company, a site of an internet service provider (ISP) or the like. Warrant-driven interception is more related to law-enforcement agencies, and non-warrant-related is more typical of intelligence systems, but this division is not binding. At the front end, for each communication it is determined at step 70 whether the communication complies with the IC. Some of the IC's conditions, such as phone number or time are compared against the IRI or another external source of information, and some are determined from the content of the communication itself, by performing analysis step 76. If the communication is determined to comply with the IC, it is captured at step 74. Since step 76 requires at least part of the communication, if there is a chance that the communication should be intercepted, it is captured at step 74, analyzed at step 76, and if determined to comply with the IC, it is passed at step 75 to the back end. If the communication does not comply with the IC, it is discarded. Analysis step 76 can comprise any type of analysis relevant for the captured communication. Voice communications can be analyzed by engines including automatic transcription, word spotting, speaker identification, speaker verification, speaker hunting, speaker recognition, phonetic search, language identification, emotion detection, and others; communication items such as fax transmitted can be analyzed using object character recognition (OCR); textual communication is optionally analyzed using any of the following: language identification, free text search, categorization, clustering, entity tagging and relationship, automatic summary, translation, or the like; internet browsing sessions are optionally captured according to the relevant warrants, for example all browsing or only to specific sites, and similarly for additional types of communication currently known or that will become known in the future. Link analysis and data mining can also be performed on relevant information. In cases wherein interception and capturing is limited, due for example to a limiting warrant limiting capturing hours or dates, or specific web addresses, the relevant logic is applied at step 70. However, step 76 can be skipped at the front end, such that all communications whose IRI comply with one or more ICs are passed to the backend. If step 76 is performed, the analysis results are passed together with the content and the IRI to the backend at step 75. At the backend, the communications are optionally reviewed at reviewing step 78. At reviewing step 78, the user is presented with the case hierarchy or with one or more communication items, and can listen to vocal communications or to one side of the communication item, view their contents, add comments, add action items, assign a communication to another user and additional operations. The user can view a textual presentation of a textual communication item or a pictorial presentation of an image, such as a fax communication. Some of the communications might be directed by a user to analysis step 76 as performed at the back end. The analysis engines used at the backend may be the same, utilize different parameters or be altogether different from the analysis engines used at the front end. The communication analysis may be human or automated. For example, a human operator can listen to calls, while an automated system can search for spotted words. The products or results of reviewing step 78 or communication analysis step 76 are optionally fed back into interception criteria determination step 70, for deleting, enhancing or changing one or more interception criteria based on actual captured communications. For example, if an interception criteria involves an e-mail address, when a user is using the address from a certain computer, the IP address of the computer can be captured, and additional interception criteria, such as an additional e-mail addresses used from this computer, can be added as an interception criteria. Another example involves IP expansion of the IP address of a computer, out of which a target sent a text file containing a certain word. Reviewing step 78 or communication analysis step 76 comprise a set of rules according to which it is decided which criteria are fed back into, and for how long. For example, if a target used an interne café, the next person using the same computer is not likely to be a target.

The reviewed or analyzed communications are stored at step 82, either for a short term or for a long term. Since not all the captured information can be reviewed prior to storage, some of the communications are stored at step 82 without being reviewed prior to storage. The user possibly updates the ICs at step 84, according to the gathered communications or updated needs. At that time, or any later time, a user can query the system, retrieve one or more stored communications according to one or more criteria and review the communications in step 86, as detailed in association with step 76 above.

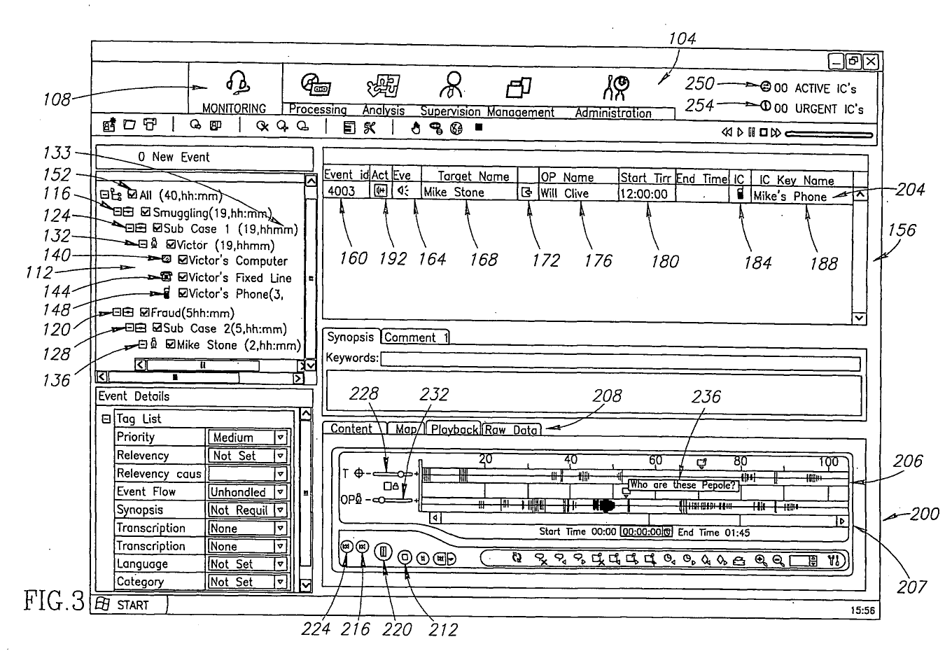

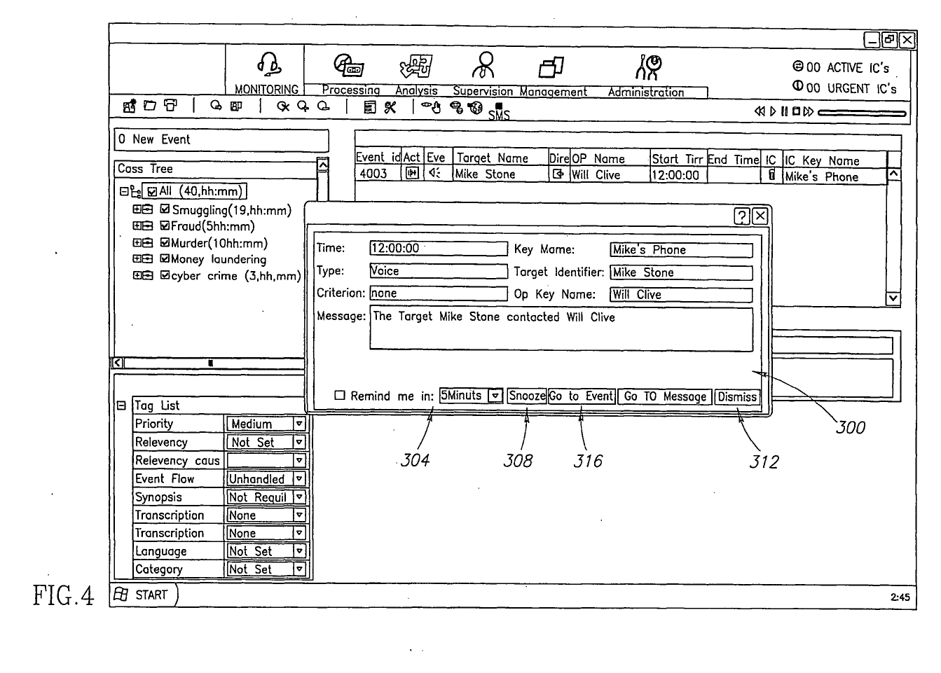

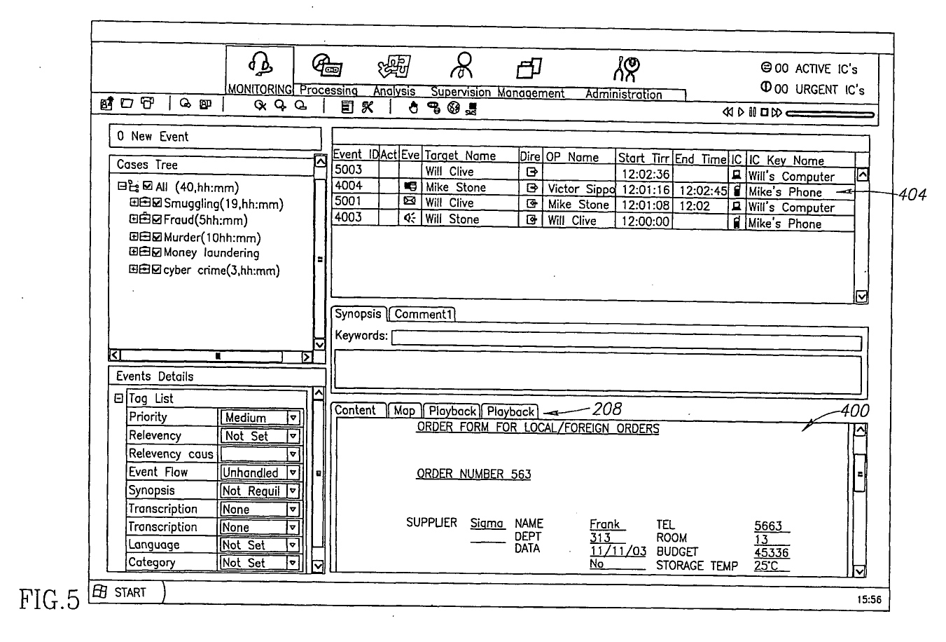

Referring now to FIGS. 3 to 13, showing various aspects of a preferred embodiment of the apparatus. FIGS. 3 to 13 are illustrations of possible computer screenshots of a preferred computerized embodiment of the disclosed invention. However, FIGS. 3 to 13 shown and explained below are exemplary only and serve merely to present and exemplify the underlying principles and methods of the disclosed invention. Persons skilled in the art will appreciate that different implementations, regarding the internals of the system, as well as its user-interface aspects can be implemented in various ways utilizing different technologies and methodologies. With the present implementation, the user can obtain within a glance as much information as possible regarding one or more interception communications, targets or other entities in the system. Mode selection bar 104 of FIG. 3 allows a user to select the mode he or she wishes to work in, subject to the user's profile (operational, management, etc.) and the allowed permissions. In FIG. 3, the user selected “Monitoring” mode by pressing button 108 and is working in monitoring mode, which provides a user-customizable display of intercepted interactions in real time or near-real-time. Area 112 of FIG. 3 shows a graphic representation of the investigations hierarchy. The top level of the hierarchy is a case, such as smuggling 116 or fraud 120, which is the parent entity which comprises one or more subjects for interception under the same investigation. Each case may comprise one or more sub-cases, such as sub case 1 124 or sub case 2 128, each sub-case regarding a subject of more focused work effort. For example, within a homicide case there may a focused investigation on a particular group of suspects. However, sub-cases are not a mandatory component in the hierarchy and can be skipped. The third level is the target, such as Victor 132 or Mike stone 136 in FIG. 3. A target is usually an individual, whose communications are marked for interception. Each target can be intercepted using one or more communication channels, such as phone, fax, computer, cellular phone or the like. The last level is the interception criteria (IC), such as Victor's computer 140, Victor's fixed line 144, or Victor's phone 148, all of FIG. 3. Next to each row in each level, the system denoted in parenthesis 124 the total number of items, (such as audio captures, video captured, e-mail messages and the like) collected at this level and its sub-levels, and the accumulated duration of audio or video captured interactions, which is important for the user for estimating the time it will take to analyze the captured material. Each IC is usually a combination of one or more parameters relating to a certain communication channel, defining which communication items are to be intercepted. An IC can relate to: one or more phone lines, possibly involving limitations such as times, dates, called number or the like; the international mobile subscriber identity (IMSI) or international mobile station equipment identity (IMEI) of a cellular phone; an e-mail address; an IP address; or other identifiers of telecommunication channels. Each one or more presented interception criteria are associated with one or more interception criteria in a back end unit. The ICs are optionally related to warrants issued by court, which authorize eavesdropping to the target. The ICs are constructed, as will be detailed below, in connection to the warrants, if available. Each component in the hierarchy, i.e. a case, sub-case, target, and IC can be associated and displayed to one or more users, and each user can view any number of hierarchy components. The components viewed by a user are determined according to a security and privileges policy, and profile definition. Profiles within the apparatus can include administrative profiles, operational profiles or master profiles, thus determining the privileges. Each user can be associated with multiple profiles, according to his or her role in one or more investigations. A checkmark such as 152 next to an item in the hierarchy indicates that the relevant item and all its sub-items, unless unchecked, are active, meaning that all checked interception criteria are active at the relevant IC operation components at the relevant front ends. The hierarchy view is preferably enabled in all modes and for all users, however, the contents presented to each user vary according to the profile, the privileges and the assignments assigned to the user. The upper right hand side pane of the screenshot, generally referred as 156 shows relevant details for each activity associated with the checked case, sub-case, target, or IC and their sub-entities in the hierarchy (e.g. all ICs under a certain checked target, all targets and all associated ICs under a checked sub-case, etc.). The relevant information includes identification and technical data, such as event ID 160, event type (telephone, fax, etc.) 164, target name 168, event direction (incoming or outgoing) 172, the other party's name (OP) 176, start time 180, IC type 184, IC name 188, and an indication 192 whether the interaction is currently active. In addition, indicators 250 and 254 indicate whether there are and active or urgent events currently going on. Although the communications are of different types, the presentation is unified, using uniform parameters, thus enabling a user to efficiently grasp the occurrences. It is possible to define communications complying with certain ICs as requiring smart-alerts, meaning that when a new interaction was captured and is being transmitted, a pop-up window will appear on the screen, notifying the investigator about the new activity, as shown in pop-pup window 300 of FIG. 4, comprising information about the event and options for the user, such as reminding in a predetermined time 304, snooze 308, dismiss 312, and go-to-event 316. Referring now back to FIG. 3, the lower right hand side, generally referred to as 200 of the screen provides a number of ways to view additional information related to highlighted interaction 204 in the upper right hand side pane. Vocal events, regardless of their origin, are preferably viewed using a playback module such as the one shown in FIG. 3. When the selected tab of tab buttons 208 is “playback”, a voice communication can be played either offline or in real-time. Real-time monitoring uses voice over IP technology. The playback module supports a wide range of playback types: stereo playback, wherein each side of the call is displayed on a separate bar, such as target bar 206 and other party bar 207, and has a separate volume control; Mixed playback, where both sides of the call are mixed into a single channel; or synchronized playback, wherein two calls can be played simultaneously, either mixed or separated. The available playback control features include: play/stop 212; pause/resume 220; jump forward/backward 216/224; loop playback of a certain period; jump anywhere within the call by pointing at the time bar; target volume control 228 and other-party volume control 232; or skip silence. The playback screen, can also present additional information, either automatically derived information such as words spotted in the voice by a word spotting engine or segments of high emotions, or user-entered data, such as comments 236, a picture of the target or the other party, a time tag, a manually entered transcription or the like. In addition, preferably in processing mode, the user is allowed to associate any of the abovementioned user-entered information items with the communication in general or with a specific point in time during the interaction, including memos, action items, or things to check. The playback screen can also present one or more IRI information items, such as transfer, hold, and the like. Referring now to FIG. 5, showing the system when the selected tab of tab list 208 is “content”. With the “content” selection, a visual communication such as a fax or web browsing, in this case the fax transmission denoted a 404, is viewed as seen in pane 400 of FIG. 5. The contents are displayed by a viewer which can display the decoded image, the event's information or both. The intercepted images are preferably presented in TIFF format, enabling multiple pages to be wrapped up in a single file. The fax viewer enables users to perform a variety of operations on the decoded image, without manipulating the original image. The operations comprise zooming, rotating, inverting and other operations. When the transferred image is coded, presenting it as a TIFF image isn't valuable. In such cases, the viewer offers the ability to view the image as raw binary data, enabling the decoding of the image by experts. The information related to the event comprises the signal level (in db); communication protocol; compression mode; error correction; sending fax; receiver fax and additional details. Area 400 can alternatively display e-mails or news events, which include beside their content, other important parameters, such as sender, receiver, subject, attachment etc. The events are preferably displayed using XML format, in order to enable their simple export to external systems. The looks and behavior of the viewer can resemble common e-mail viewers, such as MS Outlook, and the important parameters are displayed in a simple, easy to understand format, thus providing the user with a familiar environment. When the intercepted communication is an SMS, it can be viewed by an SMS viewer, displaying the contents of the SMS, as well as other relevant parameter, such as the SMS protocol, the encoding and the like. When the intercepted event is web browsing, the system's dedicated web viewer can presents the target's intercepted web browsing sessions in the same manner the target viewed them. This includes viewing JavaScript and ActiveX elements, and handling script-protected pages. “Cookies” downloaded from the web server to the target are displayed as well. When the intercepted communication is textual, such as a chat, a messenger session, an FTP or a telnet session, the content viewer actually shows a table in which every entry is displayed in a new row accompanied by its parameters such as time stamp, origin, type, etc. In case of file transfer (by FTP, DCC etc.) a link to the decoded file is displayed and the file can be opened and viewed. This form simplifies user operations on the intercepted event; the user can easily sort the entries by time, type etc. and can apply a keyword search on the content.

In addition to showing specific interactions in the abovementioned as well as additional ways, it is possible to export one or more captured interactions for analyzing in an external tool or environment. It is also possible to import analyzed information (as well as other information, such as video frames or audio captured through a microphone) not originated as captured information) back to the system. The import and export can be performed for purposes including but not limited to: analysis with tools that are not supported by the system; presentation of information, for example to a judge who is asked to issue another warrant; archiving and other purposes. Another type of information which can be imported into the system relates to one or more properties of a target, a non-target, a case, an interception criteria or any other entity, which are imported from an external source.

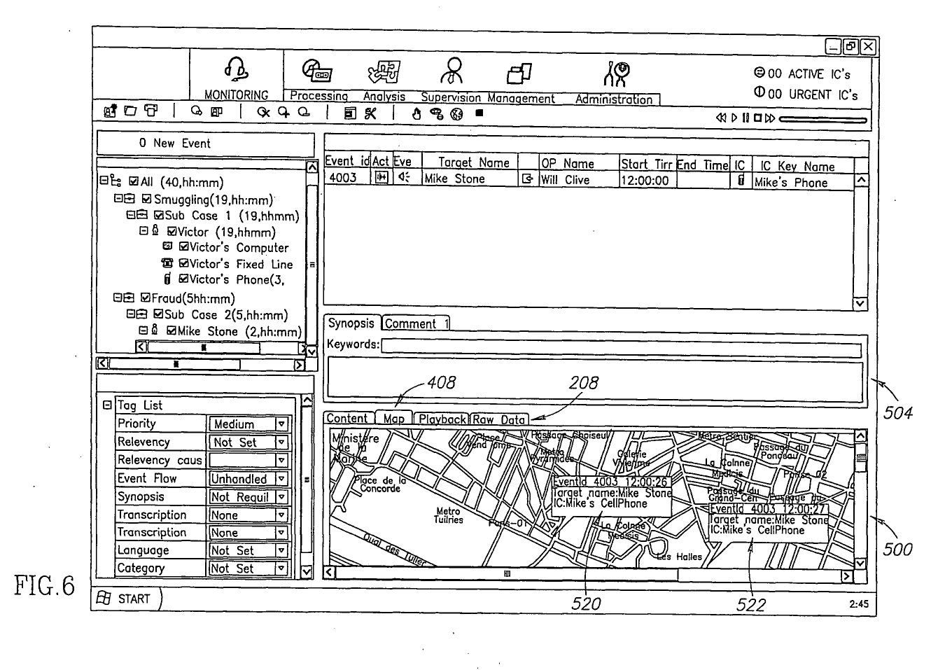

Referring now to FIG. 6, in which the active tab of tab list 208 is map tab 408. Map tab 408 is enabled when the selected communication relates to a channel for which geographic indication exists, such as a cellular phone, a fixed phone or others. The apparatus allows the user to see the location of mobile targets or a communication means associated with the target (a cellular phone) by notifications like 520 or 522 on a map 500 of the relevant area, even when the communication means is inactive. This view enables tracking down of target movements and location habits, and allows for deduction of various location-related functions, reports, graphs, behavioral patterns and the like. In the case of video communication, the video stream can be presented on the content pane. The middle right hand side pane 504 of the screen is dedicated for entering or viewing comments and synopsis, including keywords, of the interaction. As will be explained below, it is possible to search according to the entered keywords. The bottom left part of the screen lets the user who reviews a certain interaction to make indications relating to specific interaction, such as priority, language and others, and to order one or more analyses, such as translation, transcription, synopsis and others.

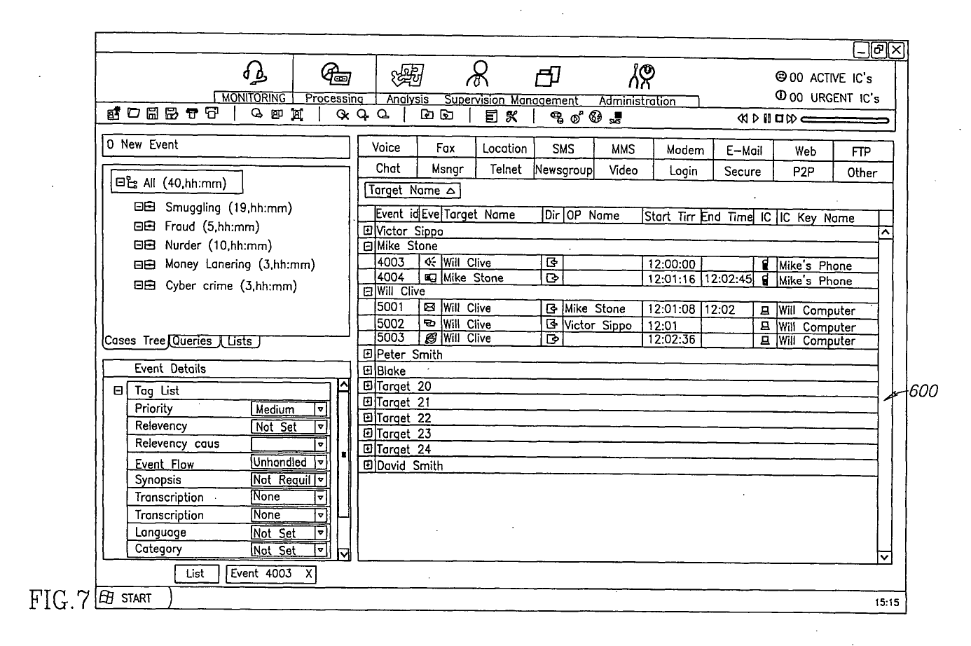

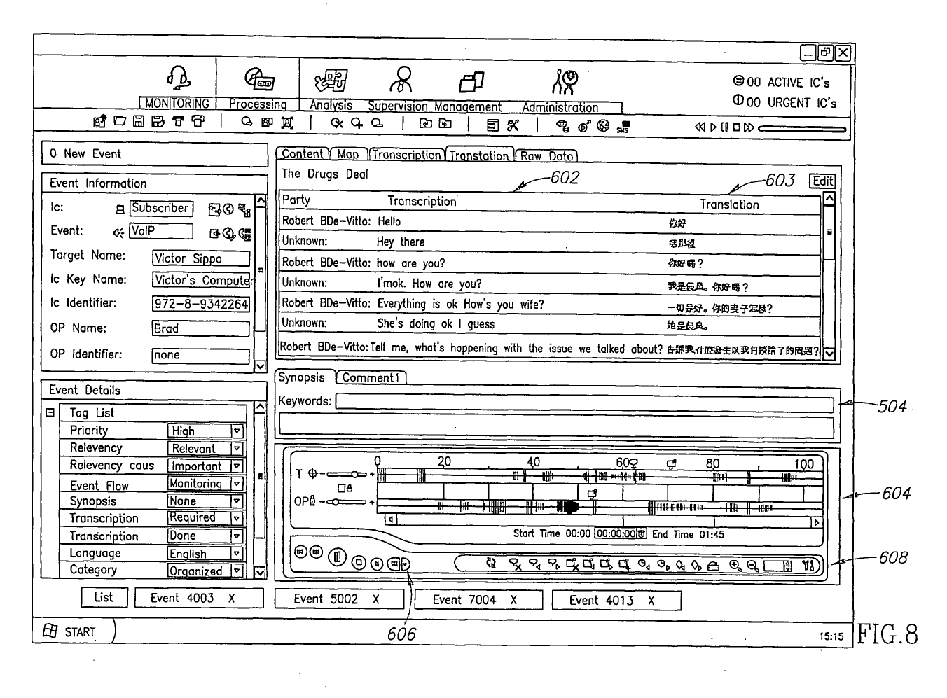

Referring now to FIGS. 7 and 8, showing the apparatus in processing mode, which is intended to be used by the personnel performing the additional processing as ordered in monitoring mode. This mode is mainly intended for off-line processing of the intercepted and stored communication items. As shown in FIG. 7, in processing mode the user is presented with a list 600 of all the communication items he is allowed to view, similarly to the list shown during monitoring. The user then selects a communication item, and is presented with various processing options, such as translation as shown in FIG. 8, transcription, or other processing activities. When using any of these options, the user can edit the contents of the pane through transcribing, translating or otherwise processing the interactions. As shown in FIG. 8, the user can transcribe the communication in area 602 or translate it in area 603, by using playback pane 604 buttons 606 at the lower part of the screen. In addition, the user can add, edit or delete comments, time tags or other indications to the processed communication by using any of buttons 608. Additionally, when multiple speakers are speaking, the transcription can be constructed such that hitting the “enter” key (or any other designated key) will be interpreted as speaker switching, and will facilitate the system in highlighting the relevant text when the words are pronounced.

Other viewing options, such as the content or the map are available as in monitoring mode. Middle right hand pane 504 allows the user to enter keywords or synopsis upon which searching is then enabled. The apparatus can be further integrated with a speech-to-text engine or a translator for automatically transcribing or translating the interactions. Even if the quality of the transcription or translation generated by the automatic tools is not satisfactory, their output can still be used as a basis for manual enhancement. In processing mode the user is able to display all communications assigned to him in a list, enables the user to

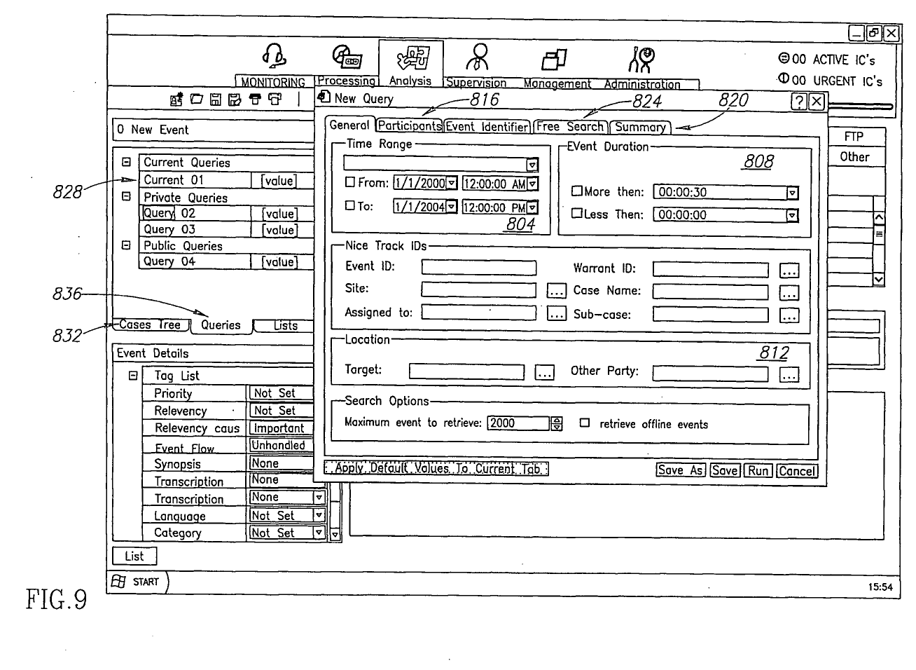

Yet another mode enabled by the apparatus is analysis mode, intended to be used by information analysts for obtaining further information from the intercepted communication items, the processes performed upon them and additional data entered by persons who worked with the information at an earlier stage. In analysis mode the user can create lists of communication items, assign the lists or parts thereof to people responsible to a certain aspect of an investigation, move, copy, or delete items. The user is also presented with an option to generate, save, run, and analyze different queries, as shown in FIG. 9, when the active tab of tab list 832 is “Queries” tab 836. A query can relate to any one or more data items associated with or contained within communications, including interception related information (IRI), such as duration or time range as indicated in 804 or 808 panes, respectively, location as indicated in pane 812, one or more participants selected in tab 816 of tab list 820, free search for words or phrases contained in a text communication, in a transcription or translation of a telephone interaction, in comments associated with the interaction, in the keywords or the synopsis of an interaction, or any combination of the above, as indicated when using tab 824. The apparatus is preferably target-oriented, i.e., when a communication is presented, the target is clearly marked, even if he or she is not a main participant in the communication. For example, in e-mail messages, the target will be highlighted even if his name is in the CC or even BCC field, in a phone conversation it will be marked even of the call was captured due to the other person, and the like. However, the queries can also relate to the other party talking with the target. The analyst can also use external visualization tools to obtain further aspects of the intercepted data or its IRI, define criteria for smart alerts, i.e., communications that require immediate attention, or additional tools. Smart alerts are not just interpreted for immediate use, but also stored for ongoing usage and continuous monitoring. The analyst can construct groups of queries as shown in upper left hand pane 828: public queries, private queries and others. The user can further create and use query templates.

The analyst can further define real time operational alerts regarding events which may require immediate decision making. To this end the system allows the analyst to define various type of alerts based on various criteria (i.e. events' fields, target information), which can be delivered to one or more users.

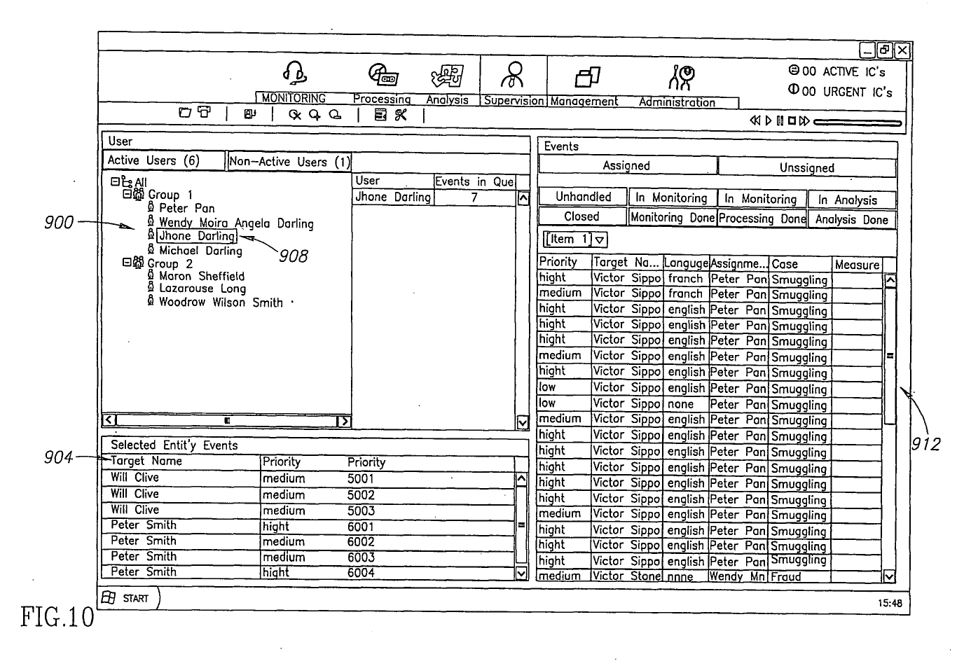

Another mode available to users is the supervision mode. This mode is especially useful in those organizations in which all intercepted communication items pass through a routing entity, which routes them to specific users. FIG. 10 shows the system in supervision mode, which enables a supervisor to see in pane 900 all users, optionally divided into groups, in pane 904 all the events that were assigned to highlighted user 908, and in pane 912 all the assigned items, the unassigned items, which items were assigned to a user or the like. The supervisor can assign one or more communications to people based on various factors, including but not limited to: language, priority, experience, work load and others. The supervision module provides the supervisor with a comprehensive view of the MC status during the shift, thus simplifying the decision-making process during peak hours and avoiding bottlenecks and processing overflows.

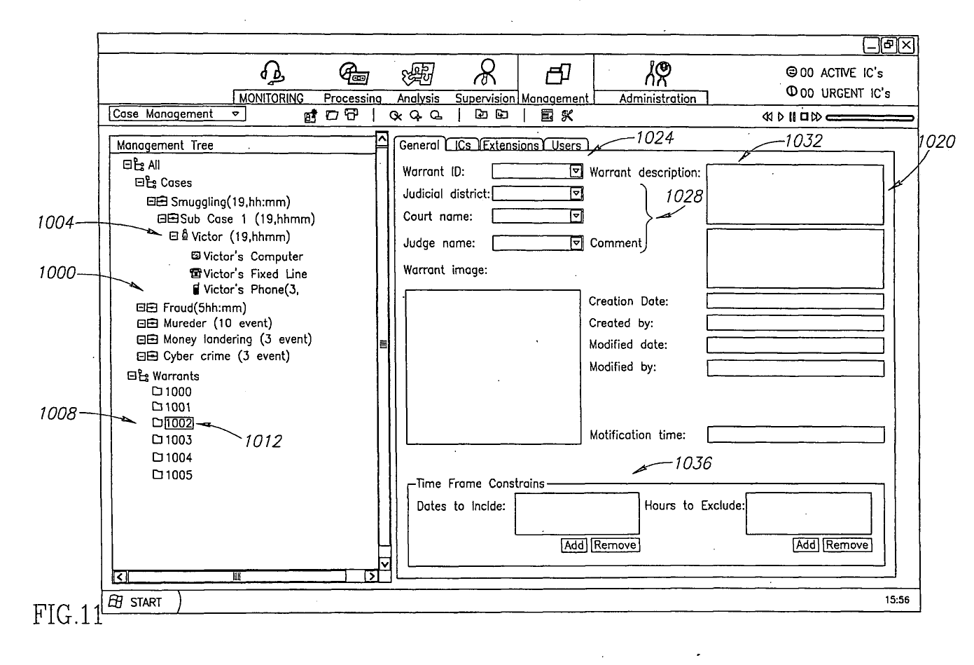

Referring now to FIG. 11 showing a preferred embodiment of the apparatus in management mode. The management mode is designed to be used mainly by operational administrators and provides various tools required for defining and modifying the system entities such as cases, targets, users etc. Some interceptions, especially those related to law-enforcement agencies (unlike intelligence-related interceptions) should be performed only under warrants, which are court orders permitting the eavesdropping to a target's telecommunications for a period of time, or under certain restrictions. Therefore, some ICs are subject to, and should be linked to specific warrants. The ICs are created are warrant-related or non warrant-related according to configuration parameters. The management mode provides tools allowing each organization to administer its entities in accordance with its operational methods and workflows. In addition, this mode allows defining user profiles, including permissions, and assigning actual users to the profile. The management mode supports at least two sections: an assignment section, which allows assigning permissions to access a certain case, target, IC or the like to a user; and a case management section, which allows for the administration of all cases and warrants (creation, modifications, deletion, etc.). As can be seen in FIG. 11, the management section allows entering specific warrants and deriving ICs from the warrants, such that two way relations exists between one or more warrants and one or more ICs. Left hand side pane 1000 of FIG. 11 contains an upper part 1004 showing the case-sub-case-target-IS hierarchy, and a lower part 1008 showing the warrants existing in the system. The details associated with highlighted warrant 1012, are shown on the right hand side pane 1020. The details include, but are not limited to warrant id 1024, judicial details 1028, warrant description 1032, warrant time frame 1036 and others. The management mode also enables the management and retention of additional data related to a target, a non-target, or an other-party register. Information can also be collected, maintained and can be accessed for an unknown target, for example a person who communicated once or more with a known target, but whose identity is not known. Such information can include known passwords, nick-names, relevant telephone numbers or any other piece of information which can be related or not related to interception. The data is accumulative and can be collected from various front-ends or any other source. This includes, for example connection to phone or other directories or databases.

Yet another available mode is administration mode, which enables a user with the appropriate privileges to technically configure the system, including servers and clients definition, load balancing between resources, integration with external tools, technical malfunctions of equipments and related alerts, or the like. The technical maintenance is performed by utilizing a standard protocol, such as SNMP which simplifies the system integration with existing systems and enables a centralized technical management using commercial tools that can be used in order to view the entire system segments and components and indicate failures and bottlenecks.

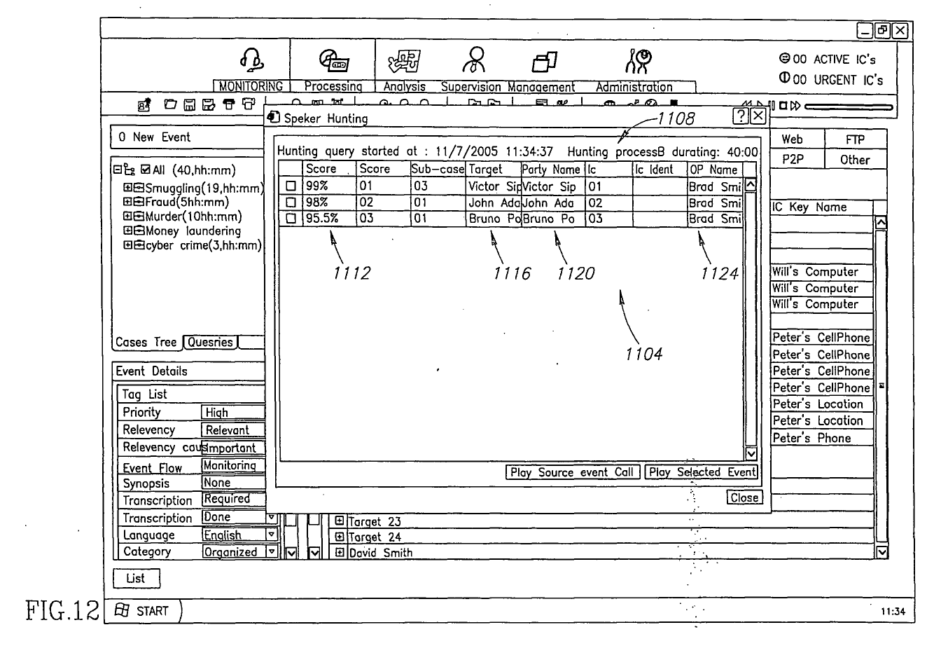

Many tools are enabled at various modes of the system. For example, tools related to voice recognition are used mainly in analysis mode. The tools include speaker verification, in which the user asks the system to assess the probability that the target or the other party speaking in a communication is indeed a certain person. Another option is speaker identification, in which the user asks to identify one or more of the speakers in a communication. The system can first present against how many voice models the speaker's voice is going to be tested, and can also limit the search by some internally derived or user-supplied criterion, such as gender, accent, age, etc. Once the identification results are presented, the user preferably grades the results, and based on the voices and the grading the system can enhance its parameters and improve the performance of future recognitions. Yet another option is speaker hunting, where the user can ask the system to locate more communications in which a speaker participating in a certain communication is speaking, whether the speaker's identity is known or not. The results of speaker hunting are shown in FIG. 12. Pane 1104 of FIG. 12 shows the hunting results for the query described at the top of the pane, marked as 1108. The query results relate to one of the calls on the right hand side of the screen. The results include score 1112, representing the probability that target 1116 is indeed party name 1120, or OP name 1124, according to the user's selection.

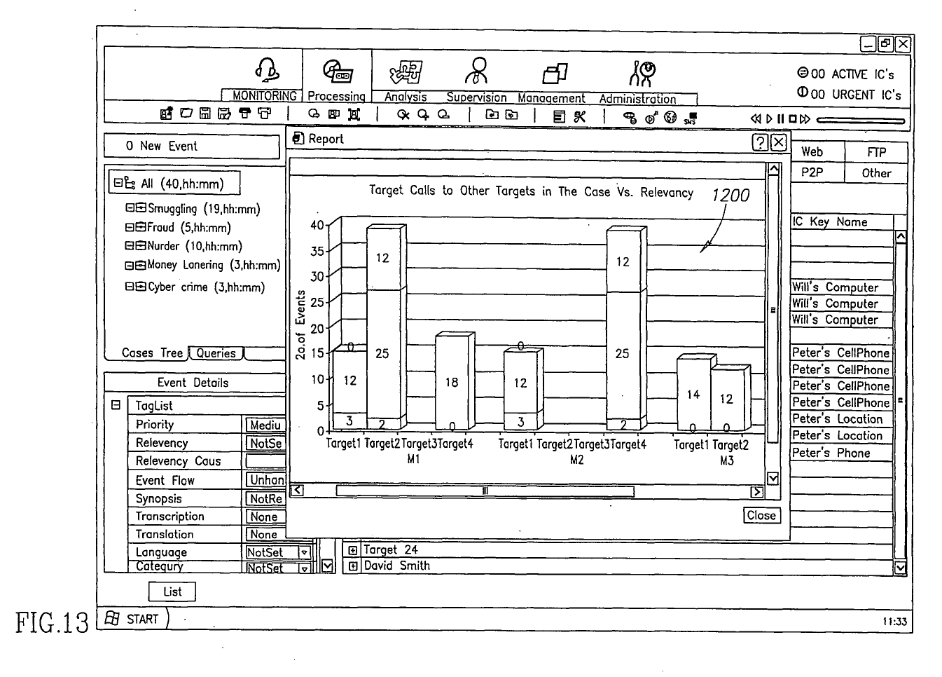

Additional options available at one or more modes of the system include for example reports, such as the number of irrelevant, relevant, and highly relevant events per target per months as shown in main pane 1200 of FIG. 13, charts of communication between channels, and others.

The apparatus enables a number of unique views, such as a favorites list, showing selected communications possibly belonging to multiple ICS, targets, sub-cases or cases. Another viewing option is a simulation of a chain of events, i.e. presenting a multiplicity of events, i.e. communication items according to the time line at which they occurred.

Another functionality is the recognition of “non-target”, i.e., identifying that a certain subject, who is not a known target is the “other party” in multiple communications, and should therefore be identified and possibly become a target himself. The other party is preferably associated with parameters related to multiple communication channels, such as phone number, cellular phone number, e-mail and the like, recognized through one or more communications with one or more known targets. When a person who is not a known target in the system communicates with a known target, he or she are entered into a pool of interception criteria and can become a target immediately or at a later time.

The system can further perform data retention, i.e. keep the IRI and utilize it at a later time, for purposes such as showing the locations of targets when performing communications on a map, deducing targets' patterns of behaviors and the like. In addition, it is also possible to introduce into the system external communications which were not intercepted by a front end of the system, such as TV recordings relating to a target, external recordings of phone conversations and others. The added communications can be analyzed and viewed similarly to the intercepted items. Certain targets or certain IC parameters, such as a VIP's phone line can be marked as belonging to a “white-list”, i.e. a target tot listened to, even when a target contacts them. Additionally, certain parameters can be marked as non-relevant, such as the number of an information service, the URL of a home page of a large portal or others.

It will be appreciated by persons skilled in the art that the present invention is not limited to what has been particularly shown and described hereinabove. Rather the scope of the present invention is defined only by the claims which follow.

1. A target-oriented apparatus for capturing an at least one communication item associated with an at least one target according to an at least one interception criteria, the apparatus comprising:
an at least one front end component, the front end component comprising:
at least one interception criteria operation component for determining whether an at least one communication item complies with the at least one interception criteria; and
at least one capturing component for capturing the at least one communication item; and
an at least one back end component, the back end component comprising:
at least one front end interface server for interfacing between the at least one capturing component and the back end component;
at least one hierarchy definition and update component, for defining at least one hierarchy comprising at least one interception criteria; and
at least one query engine for filtering the at least one communication item according to the at least one interception criteria.

2. The apparatus of claim 1 wherein the hierarchy further comprises at least one of the following: an at least one case, an at least one sub-case, or an at least one target.

3. The apparatus of claim 1 wherein the backend comprises a hierarchy presentation component for presenting the at least one hierarchy.

4. The apparatus of claim 1 wherein data related to a non-target person communicating with the at least one target is collected.

5. The apparatus of claim 1 wherein data related to an unknown target communicating with the at least one target is collected.

6. The apparatus of claim 1 wherein the at least one interception criteria is associated with an at least one warrant.

7. The apparatus of claim 1 further comprising an at least one reviewing component for reviewing the at least one communication item.

8. The apparatus of claim 1 wherein the at least one communication item is any of the following: a telephone conversation; a fax; an SMS; a cellular telephone conversation; an e-mail message; an internet browsing session; an FTP session; an MMS; a P2P session; an instant messaging session; a chat session; a login operation; a modem call; a data transfer; a GPRS communication; the location of a cellular telephone; or a video conference.

9. The apparatus of claim 1 wherein the at least one front end or the at least one back end contains an at least one analysis engine.

10. The apparatus of claim 9 wherein the at least one analysis engine is any of the following: a speech to text engine; a word spotting engine; an emotion detection engine; a language identification engine for audio; a speaker identification engine; a speaker hunting engine; a speaker separation engine; a speaker recognition engine; a phonetic search engine; a text language identification engine; a free text search engine; a categorization engine; a clustering engine; an entity tagging and relationship engine; an automatic summary engine; a language translation engine of the content; a face recognition engine; or an OCR engine of captured images.

11. The apparatus of claim 7 wherein the reviewing component comprises a map presentation component for presenting an at least one map.

12. The apparatus of claim 11 wherein the at least one map comprises an at least one indication for an at least one location of an at least one communication means associated with an at least one target.

13. The apparatus of claim 7 wherein the reviewing component comprises an at least one playback component for playing an at least one vocal communication item.

14. The apparatus of claim 13 wherein the playback component presents at least one indication of an at least one event from the following list: a time tag, a spotted word, a spotted phrase, a segment with high emotion detected, a comment, interception related information, DTMF, or an action item.

15. The apparatus of claim 7 wherein the reviewing component is a content presentation component for presenting the contents of an at least one visual communication, or a textual presentation component for presenting the contents of an at least one textual communication.

16. The apparatus of claim 1 further comprising a data retention component for preserving an at least one additional data item.

17. The apparatus of claim 1 further comprising a user interface, the user interface having at least one of the following modes: a monitoring mode; a processing mode; an analysis mode; a supervision mode; a management mode; an administration mode.

18. A method for reviewing an at least one communication item, the method comprising the steps of:
defining a hierarchy, said hierarchy comprising at least one interception criteria, said at least one interception criteria associated with an at least one target;
determining whether an at least one communication item complies with said at least one interception criteria;
capturing the at least one communication item;
passing the at least one communication item to an at least one back end component; and
analyzing the at least one communication item.

19. The method of claim 18 further comprising a step of using an at least one result of the analyzing step for deleting, adding, or changing an at least one interception criteria belonging to the hierarchy.

20. The method of claim 18 further comprising a step of storing the at least one communication item.

21. The method of claim 18 further comprising a reviewing step of the at least one communication item.

22. The method of claim 21 wherein the reviewing step comprises listening to an at least one speaker of an at least one vocal communication item, or viewing an at least one textual presentation of a textual communication or a pictorial presentation of an image.

23. The method of claim 18 wherein the at least one communication item is any of the following: a telephone conversation; a fax; an SMS; a cellular telephone conversation; an e-mail message; an internet browsing session; an FTP session; an MMS; a P2P session; an instant messaging session; a chat session; a login operation; a modem call; a data transfer; a GPRS communication; the location of a cellular telephone; or a video conference.

24. The method of claim 18 wherein analyzing the at least one communication item uses at least one of the following engines: a speech to text; a word spotting; an emotion detection; language identification for audio; speaker identification; speaker hunting; speaker separation; speaker recognition, phonetic search, text language identification, free text search, categorization, clustering, entity tagging and relationship, automatic summary, face recognition, language translation of the content, or OCR engine of captured images.

25. The method of claim 18 further comprising a real-time alert presentation step for presenting in real-time or near-real-time an alert concerning an at least one communication item.

26. The method of claim 18 further comprising a step of presenting on a map at least one indication for an at least one location of an at least one communication means associated with an at least one target.

27. The method of claim 18 further comprising an IP expansion step for determining additional information about a target.
